(19) United States
(12) Patent Application Publication
(10) Pub. No.: US 2007/0002511 A1
(43) Pub. Date: Jan. 4, 2007

(54) Meter-base surge protector

(76) Inventor: Nisar Chaudhry, Huntington Station, NY (US)

Correspondence Address: MORGAN & FINNEGAN, L.L.P., 3 World Financial Center, New York, NY, 10281-2101, US

(21) Appl. No.: 11/053,916

(22) Filed: Feb. 10, 2005

(51) Int. Cl. H02H 9/06

(52) U.S. Cl. 361/118

(57) ABSTRACT

A meter-base surge protector adapted to be connected between multiple incoming power lines and a neutral line at a meter comprises first and second metal oxide varistors, which are each respectively connected in series to first and second thermal cut-offs and a gas discharge tube. The first and second thermal cut-offs are each connected to separate incoming power lines. The gas discharge tube is also connected to the incoming neutral line. The meter-base surge protector also includes a microcontroller for monitoring and detecting the voltage status at monitoring points within the circuit, or system, for detecting circuit, or system, malfunction. Upon the detection of a malfunction, the microcontroller activates a non-surge protection status indicator.

### FIELD OF THE INVENTION

The apparatus according to the present invention relates generally to building entrance surge protectors and, more particularly, to a building entrance power meter-base surge protector connected between a building entrance power meter and the power meter base and to the display of surge protection status of the apparatus.

### BACKGROUND OF THE INVENTION

The field of surge protectors connected between electrical AC power lines and building entrances has focused on the use of a surge protector circuit, or a plurality of sub-circuits, each comprised of a plurality of electrically parallel metal oxide varistors (MOV) connected in series to a gas discharge tube (GDT). One such surge protector is the building entrance surge protector disclosed in U.S. Pat. No. 6,778,375, entitled “Hybrid MOV/Gas-Tube AC Surge Protector For Building Entrance”, issued on Aug. 17, 2004 to Gerald B. Hoopes and assigned to Panamax, Petaluma, Calif., hereinafter referred to as “the Hoopes patent”. The Hoopes patent utilizes a surge protector circuit or plural sub-circuits connected between single-phase or multi-phase AC power lines, at the MOV side of each protector circuit or sub-circuit, and the building ground, at the GDT side of each protector circuit or sub-circuit. With this type of arrangement, multiple surge protection circuit paths between the same AC power line and the building ground are available through any one of a plurality of MOV and GDT combinations. In such a multi-phase arrangement, each of the multi-phase power lines are connected to the building ground through a plurality of separate and distinct gas discharge tubes in which a breakdown on at least one of the multi-phase lines will not cause a breakdown on any of the other multi-phase power lines.

The Hoopes patent, however, does not disclose a building entrance power meter-base multi-phase surge protector in which each multi-phase power line is connected, at the building entrance, to a neutral line through an MOV in series with a single GDT, wherein each MOV is connected to an electrode of the GDT and a separate electrode of the GDT is connected to the neutral line. The Hoopes patent also does not disclose a device that monitors the voltage status of the surge protector circuit, or sub-circuits, to determine a protector malfunction and displays a non-surge protection condition.

In addition, the Hoopes patent discloses a thermal fuse connected between each of the MOVs and their respective AC power line to limit surge voltage. One distinct disadvantage of thermal fuses is that once they have been disabled they must be replaced. Although the Hoopes patent teaches the use of multiple thermo fuses to protect each AC power line, the surge protector disclosed thereby is only functional for a limited number of over voltage occurrences.

Another type of surge protector is shown in U.S. Pat. No. 4,455,586, entitled, “High Voltage Filtering And Protection Circuit”, issued Jun. 19, 1984, to Thomas McCartney, and assigned to ONEAC Corporation, Bannockburn, Ill., hereinafter referred to as “the McCartney patent”. The McCartney patent discloses a multi-phase surge protection circuit connecting each AC power line and neutral line to ground via various protection circuits. In one embodiment of the McCartney patent, each AC power line and the neutral line is connected to ground via a series of two protection circuits made up of transient voltage suppressors, such as, high voltage rated silicon p-n junction devices, in parallel with capacitors. In another embodiment of the McCartney patent, an arrangement formed using a series of transient voltage suppressors in parallel with a series of capacitors is utilized to connect the AC power lines to ground. A further embodiment of the McCartney patent uses parallel transient voltage suppressors directly connected in series with a common transient voltage suppressor that is connected in series with a gas discharge tube. An additional embodiment of McCartney utilizes parallel bi-directional transient voltage protectors directly connected to a common bi-directional transient voltage protector that connects to ground via a gas discharge tube.

Still another type of surge protector is shown in U.S. Pat. No. 5,428,494, entitled, “Power Line Protector, Monitor And Management System”, issued Jun. 27, 1995, to Om Ahuja, and assigned to Omtronics Corporation, Bellaire, Tex., hereinafter referred to as “the Ahuja patent”. The Ahuja patent discloses a multi-stage, multi-function power line based power protection, monitoring, and management system, which includes over voltage protection utilizing a three-electrode GDT, MOVs for providing line to ground and line to line transient protection and voltage limiting across the line connected equipment, ground fault circuit interrupter, fuses, and positive temperature coefficient resistors integrated with the GDT, MOV, and transient suppressor. The Ahuja patent also includes a stage that includes, for example, a microcontroller, or microprocessor, that continually monitors and responds to power line and power load conditions, and in accordance with other predetermined internal/external hardware or software conditions switching on or off power sources or other loads.

Neither the McCartney patent nor the Ahuja patent discloses a building entrance power meter-base multi-phase surge protector in which each multi-phase power line is connected, at the building entrance, to a neutral line through an MOV in series with a single GDT, wherein each MOV is connected to an electrode of the GDT and a separate electrode of the GDT is connected to the neutral line. Likewise, neither the McCartney patent nor the Ahuja patent discloses a device that monitors the voltage status of the surge protector circuit, or sub-circuits, to determine a protector malfunction and displays a non-surge protection condition.

### SUMMARY OF THE INVENTION

The present invention overcomes the disadvantages of the prior art surge protectors as exemplified by the patents already discussed. The present invention discloses a meter-base surge arrestor/protector that mounts between a residential meter and meter base at the building entrance. The present invention discloses a novel and improved building entrance power meter-base multi-phase surge protector in which each multi-phase power line is connected at the building entrance to a neutral line through an MOV in series with a single GDT, wherein each MOV is connected to an electrode of the GDT and a separate electrode of the GDT is connected to the neutral line. The GDT and MOV combination surge protector circuit of the invention has a reduced capacitance, which enables high speed broadband data transmission over power lines without significant attenuation, and leakage current though the MOVs is reduced ensuring a long service life for the meter-base surge protector.

The GDT and MOV combination surge protector circuit also includes thermal cut-offs (TCO) connected in series and thermal communication with the MOVs. The use of TCOs in lieu of fuses allows the surge protector to operate at higher temperatures and loads. Each TCO is physically positioned within the surge protector circuit so as to be in at least thermal communication with its respective MOV. Such thermal communication includes any relative physical positioning between the TCOs and the MOVs that allows heat dissipated by the MOVs to be received by the TCOs, including placement of the TCOs in actual physical contact with the MOVs. With this arrangement, heat buildup in the MOVs will be distributed to the TCOs.

The present invention overcomes the functional limitations of the prior art fuses by utilizing TCOs which protect the surge protector circuit through an increase in resistance with an increase in temperature. During a surge condition that exceeds the electrical capabilities of the surge protector of the present invention, the TCOs will eliminate current flow therethrough due to excessive heat build-up in the TCO. When the excessive surge condition has subsided, current flow is reestablished through the TCOs once the TCOs have cooled to an operating temperature.

The GDT and MOV combination surge protector circuit of the present invention also includes a microcontroller, or microprocessor, for monitoring the voltage status at various monitoring point locations within the surge protector circuit itself to determine whether or not the surge protector circuit is providing surge protection. The microcontroller receives negligible operating power via the AC power lines. In the event one or more of the components of the surge protector circuit fails, or otherwise malfunctions, the microcontroller will sense a voltage status change at one or more of the monitoring points within the circuit and signal the premises owner, via a blinking light emitting diode, audible alarm, or other warning mechanism, that surge protection has been interrupted and is currently not available. The microcontroller also sends low frequency signals over the power lines, or other means, to alert the power utility of the surge protection circuit failure or malfunction.

The foregoing specific objects and advantages of the invention are illustrative of those that can be achieved by the present invention and are not intended to be exhaustive or limiting of the possible advantages which can be realized. Thus, these and other objects and advantages of this invention will be apparent from the description herein or can be learned from practicing the invention, both as embodied herein or as modified in view of any variations which may be apparent to those skilled in the art.

### BRIEF DESCRIPTION OF THE DRAWINGS

The accompanying figures illustrate the details of the preferred meter-base surge arrestor/protector of the present invention. Like reference numbers and designations used herein refer to like elements.

FIG. 1 is a schematic diagram of the surge protector circuit in accordance with an embodiment of the present invention;

FIG. 2 is a partial schematic diagram showing the physical proximity of a thermal cut-off and a metal oxide varistor in accordance with an embodiment of the present invention;

FIG. 3 is a longitudinal view of the gas discharge tube in accordance with an embodiment of the present invention;

FIG. 4 is a block diagram of the microcontroller in accordance with an embodiment of the present invention; and

FIG. 5 is a flow diagram of the surge protector circuit monitoring method in accordance with an embodiment of the present invention.

### DETAILED DESCRIPTION OF THE INVENTION

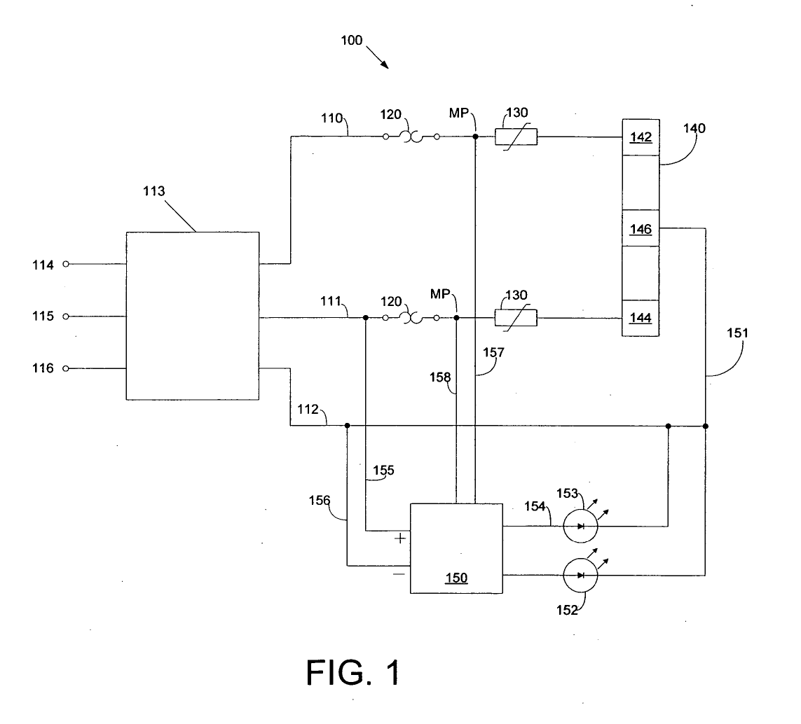

FIG. 1 is a schematic diagram of surge protector circuit 100 of the present invention. Surge protector circuit 100 includes conductors 110, 111, and 112 that are respectively adapted to be connected, via building power meter 113, to AC power line 114, AC power line 115, and neutral line 116. Conductor 110 is connected to first TCO 120, which is connected in series with first MOV 130 and first electrode 142 of three-electrode GDT 140. Conductor 111 is likewise connected to second TCO 120, which is connected in series with second MOV 130 and second electrode 144 of three-electrode GDT 140. Any arrangement and number of AC power lines, conductors, MOVs, TCOs, electrodes and GDTs may be utilized in the invention in order to achieve the functions and advantages stated herein.

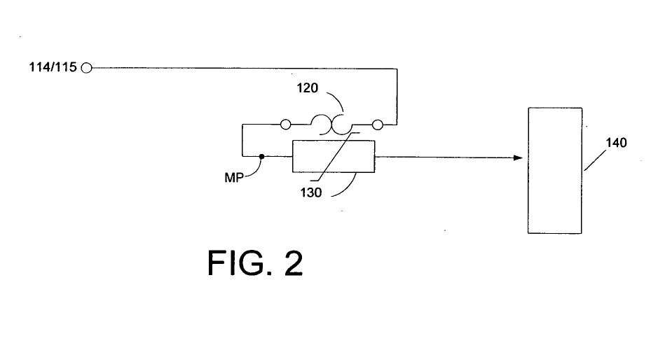

As shown in FIG. 2, the TCOs and MOVs are physically positioned in proximity, or physical contact, with one another so as to allow heat generated and dissipated by for example MOV 130 to be distributed to for example respective TCO 120. The proximity of TCO 120 and MOV 130 allows TCO 120 to monitor and react to heat build up in respective MOV 130 and, more particularly, excessive heat build up in MOV 130. Suitable TCOs are available as Microtemp Thermal Cutoffs made by Thermodisc, Incorporated, 1320 South Main Street, Mansfield, Ohio, 44907-0538, under part number G4A01084C. Suitable MOVs are available from MAIDA Development Company under part number ZV0181 RA 630, which have a breakdown voltage of about 300 volts and a maximum clamping voltage of about 465 volts.

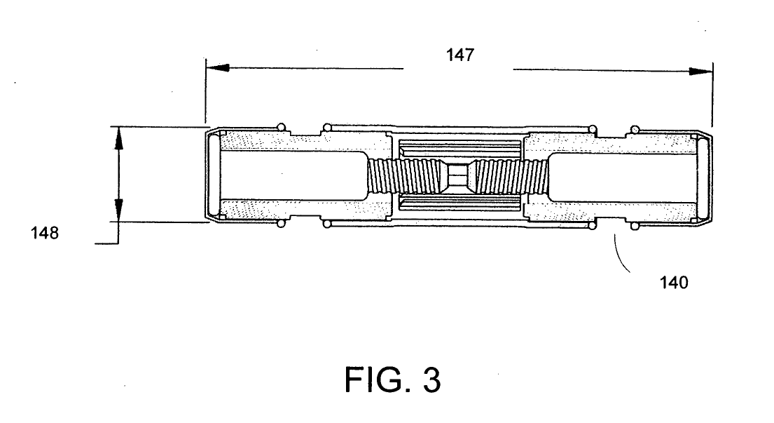

FIG. 3 illustrates an exemplary gas discharge tube 140 suitable for use in the invention. Gas discharge tube 140 has three electrodes, one on each end and one disposed between the end electrodes, for example, in the middle of gas discharge tube 140. Any number or arrangement of electrodes can be utilized in the invention. Gas discharge tube 140 may preferably have a length 147 of approximately 1.75 inches and width 148 of approximately 0.335 inches and may include any number of electrodes, preferably, at least three electrodes. The dimensions of the gas discharge tube are preferably substantially larger than the dimensions of prior art gas discharge tubes utilized in surge detectors in order to accommodate higher surge currents, preferably, at least as high as 40 KAmps. A suitable GDT may be a TII 31 D gas tube, which is available from TII Network Technologies, Inc., Copiague, N.Y., and has a breakdown voltage in the range of 350 volts to 600 volts.

The unique configuration of the surge protector circuit of the invention wherein each AC power line is connected at the building entrance to a neutral line through an MOV in series with a single GDT, and wherein each MOV is in thermal contact with a TCO, enables high speed broadband data transmission over power lines to pass through without significant attenuation. The GDT and MOV combination surge protector circuit preferably has an effective capacitance as low as about 15 pF. In addition, the use of TCOs instead of fuses enables the surge protector of the invention to operate at higher temperatures and loads preferably greater than 20 KAmps.

The surge protector circuit 100, as shown in FIG. 1, includes microcontroller 150 that is connected via conductor 151 to both the neutral line 112 and a third electrode 146 of three-electrode GDT 140. A suitable microcontroller is microchip 12F629 available from DigiKey Inc., although other microcontrollers, or microprocessors, may be used. An LED 152 is included between the microcontroller 150 and neutral line 112, as shown in FIG. 1, via conductor 151. An LED 153 is also included between the microcontroller 150 and neutral line 112 via conductor 154. Preferably, LED 152 may be red and LED 153 may be green, although other colors may respectively be used. Moreover, any number or arrangement of LEDs may be used in the invention.

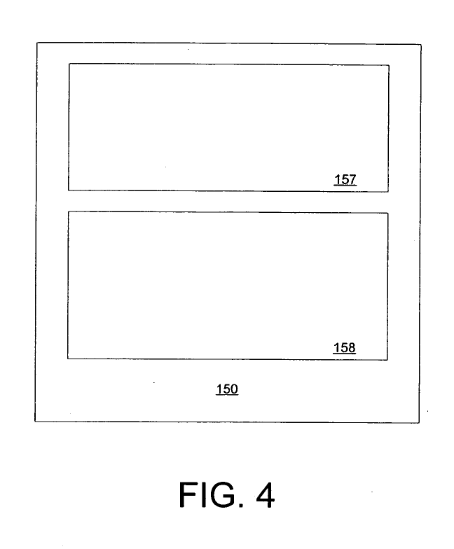

Microcontroller 150, as shown in FIG. 1, receives power for operation via conductors 155 and 156, respectively. Conductor 155 is connected between microcontroller 150 and AC power in line 115 up-line of TCO 120. Conductor 156 is connected between microcontroller 150 and neutral line 112. A central processing unit (CPU) 157 is included in the architecture of microcontroller 150, as shown in FIG. 4, as well as an electrically erasable programmable read-only memory (EEPROM) 158. CPU 157 of microcontroller 150 monitors the status of the voltage condition at a point between each of the serially connected TCO 120 and MOV 130, through software applications stored in EEPROM 158, and, provides visual, audio, and/or electronic signals as to whether or not the surge protector circuitry is providing surge protection. In this manner, microcontroller 150 provides the owner with a visual signal that surge protection is currently being provided by the surge protection circuit 100 or, when the surge protector circuit has experienced a malfunction, a visual, audio, or electronic signal to the owner and/or power utility that a malfunction has occurred and surge protection is not currently being provided. Once programmed, EEPROM 158 of microcontroller 150 can sustain the software for more than 40 years. Each conductor 157 and 158 connect microcontroller 150 to the monitoring point (MP) between each pair of serially connected TCO and MOV, as shown in FIG. 1.

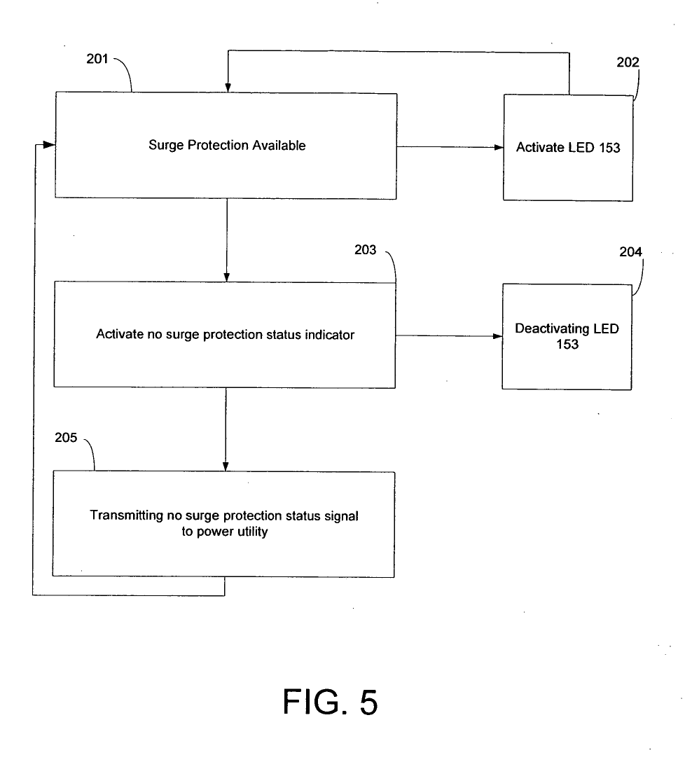

During operation of surge protector circuit 100, microcontroller 150 draws negligible power from conductors 111 and 112 through conductors 155 and 156, as shown in FIG. 1. Surge protector circuit 100 uses negligible power for operation. Microcontroller 150 continually monitors the status of the voltage condition at monitoring points MP located between each pair of serial connected TCO 120 and MOV 130. In step 201 of FIG. 5, if CPU 157 of microcontroller 150, via software modules stored in EEPROM 158 of microcontroller 150, determines that the surge protector circuit is properly providing surge protection, then a signal is sent by CPU 157 to activate LED 153 in step 202 of FIG. 3. Activating LED 153, which is visible on the outside of the surge protector, by, for example, a green light, provides a visible indication that the surge protector circuit is in a surge protection status and properly functioning.

However, when surge protector circuit 100 experiences a malfunction, such as, for example, when one or more of the surge protector circuit components malfunction or completely fail, or otherwise fails to provide surge protection, microcontroller 150 detects a change in the voltage status at one or more of the monitoring points MP. During a malfunction, no surge protection along either, or both, of AC power lines in 114 and 115 may be available. In that instance, CPU 157 of microcontroller 150, during step 203, determines that no surge protection is available; a signal is sent in step 203 to activate the non surge protection status indicator, such as, for example, LED 152, as shown in FIG. 1. In one embodiment, LED 152 is controlled to begin blinking a red light on and off at a rate of about two seconds on and one second off until the malfunction has been resolved or the surge protector has been replaced. The blinking LED 152 provides a visual indication that a malfunction has occurred and that surge protection is currently not available.

In step 205 of FIG. 5, CPU 157 of microprocessor 150 transmits a non surge protection status signal to the power utility. The non surge protection status signal takes the form of a low power frequency signal that is transmitted to the power utility over the power lines connected to the surge protector circuit. Alternatively, the non surge protection status signal also includes a signal readable by way of electronic meter readers, or other visual indicators at the meter. Furthermore, surge protector circuit 100 may also include means for producing an audible alarm in a form of, for example, short audio beeps for audibly alerting the premises owner that a malfunction has occurred and that no surge protection is currently available. When the surge protector malfunction has been repaired, or a replacement surge protector has been installed, microprocessor 150 extinguishes the blinking red LED 152 and/or audio alarm and steadily illuminates the green LED 153 signifying that surge protection has been restored and is currently available. During a malfunction, or other non surge protection condition, the green LED 153 is extinguished in step 204, as shown in FIG. 5.

Although illustrative embodiments have been described herein in detail, it should be noted and understood that the descriptions and drawings have been provided for purposes of illustration only, and that other variations both in form and detail can be added thereupon without departing from the spirit and scope of the invention. The terms and expressions have been used as terms of description and not terms of limitation. There is no limitation to use the terms or expressions to exclude any equivalents of features shown and described or portions thereof.

1. A meter-base surge protector apparatus adapted to be connected between multiple incoming power lines and a neutral line comprising:
a first varistor connected in series to a first incoming power line, a first thermal cut-off and a first end electrode of a gas discharge tube, said first thermal cut-off disposed in thermal communication with said first varistor;
a second varistor connected in series to a second incoming power line, a second thermal cut-off and a second end electrode of said gas discharge tube, said second thermal cut-off disposed in thermal communication with said second varistor;
a middle electrode of said gas discharge tube connected to an incoming neutral line; and
a microcontroller for monitoring and detecting surge protector malfunctions.

2. The surge protector apparatus recited in claim 1, wherein said varistors and said gas discharge tube have an effective capacitance of less than 15 pF.

3. The surge protector apparatus recited in claim 1, wherein said varistors and said gas discharge tube have an effective capacitance of about 15 pF.

4. The surge protector apparatus recited in claim 1, having a load capacity greater than 20 KAmps.

5. The surge protector apparatus recited in claim 1, wherein said thermal cut-offs are in physical contact with said varistors.

6. The surge protector apparatus recited in claim 1, further comprising an additional varistor connected in series to an additional incoming power line, an additional thermal cut-off and an additional electrode of said gas discharge tube.

7. A meter-base surge protector apparatus adapted to be connected between multiple incoming power lines and a neutral line comprising:
a first varistor connected to a first incoming power line and a first electrode of a gas discharge tube;
a second varistor connected to a second incoming power line and a second electrode of said gas discharge tube; and
a third electrode of said gas discharge tube connected to an incoming neutral line.

8. The surge protector apparatus recited in claim 7, further comprising at least one thermal cut-off connected to said first and second varistors.

9. The surge protector apparatus recited in claim 8, wherein said at least one thermal cut-off is disposed in thermal communication with said first and second varistors.

10. The surge protector apparatus recited in claim 7, further comprising a microcontroller for monitoring and detecting surge protector malfunctions.

11. The surge protector apparatus recited in claim 7, wherein said varistors and said gas discharge tube have an effective capacitance of less than 15 pF.

12. The surge protector apparatus recited in claim 7, having a load capacity greater than 20 KAmps.

13. The surge protector apparatus recited in claim 8, wherein said a least one thermal cut-off is in physical contact with said first and second varistors.

14. The surge protector apparatus recited in claim 7, further comprising an additional varistor connected to an additional incoming power line and an additional electrode of said gas discharge tube.

15. A meter-base surge protector apparatus adapted to be connected between multiple incoming power lines and a neutral line comprising:
at least one thermal cut-off connected to at least one varistor and at least one incoming power line, wherein said at least one thermal cut-off is in thermal communication with said at least one varistor.

16. The meter-base surge protector apparatus recited in claim 15, wherein said at least one thermal cut-off is in physical contact with said at least one varistor.

17. The meter-base surge protector apparatus recited in claim 15, further comprising a gas discharge tube, wherein said gas discharge tube is connected with said at least one varistor at a first electrode and connected to said neutral line at a second electrode.

18. The meter-base surge protector apparatus recited in claim 17, further comprising a second thermal cut-off connected to a second varistor and a second incoming power line, wherein said second thermal cut-off is in thermal communication with said second varistor and said second varistor is connected to a third electrode of said gas discharge tube.

19. A meter-base surge protector apparatus adapted to be connected between multiple incoming power lines and a neutral line, comprising a microcontroller for monitoring and detecting surge protector malfunctions.

20. The meter-base surge protector apparatus of claim 19, wherein said microcontroller, upon detection of a malfunction, activates a non-surge protection status indicator.

21. The meter-base surge protector apparatus of claim 19, wherein said microcontroller, upon detection of a malfunction, transmits a low frequency signal for alerting a power utility of the malfunction and non-surge protection condition.

22. The meter-base surge protector apparatus of claim 21, wherein said low frequency signal may be transmitted over said incoming power lines.

23. The meter-base surge protector apparatus of claim 20, wherein said non-surge protection status indicator is a light emitting diode connected between said microcontroller and said neutral line.

24. The meter-base surge protector apparatus of claim 23, wherein said light emitting diode activated by said microcontroller repeatedly blinks on for a first predetermined time period and off for a second predetermined time period.

25. The meter-base surge protector apparatus of claim 24, wherein said first predetermined time period is about two seconds and said second predetermined time period is about one second.

26. A method for monitoring a surge protection status of a meter-base surge protector apparatus, the method comprising the steps of:
connecting multiple incoming power lines to said surge protector apparatus;
connecting a neutral line to said surge protector apparatus;
monitoring a voltage status of said surge protector apparatus at one or more locations in said surge protector apparatus;
determining status of surge protection of said surge protector apparatus from said monitored voltage status; and
activating a no surge protection status indicator when surge protection is determined to be in a no surge protection status.

27. A storage medium storing machine readable program codes for determining a surge protection status of a surge protector, said machine readable program codes having control modules comprising the steps of:
monitoring a voltage status of said surge protector apparatus at one or more locations in said surge protector apparatus;
determining status of surge protection of said surge protector apparatus from said monitored voltage status; and
activating a no surge protection status indicator when surge protection is determined to be in a no surge protection status.
